(19) United States
(12) Patent Application Publication
(10) Pub. No.: US 2009/0311530 A1
(43) Pub. Date: Dec. 17, 2009

(54) SILVER NANOWIRE, PRODUCTION METHOD THEREOF, AND AQUEOUS DISPERSION

(75) Inventors: Hiroyuki HIRAI, Kanagawa (JP); Yoshiko NIINO, Kanagawa (JP); Nori MIYAGISIMA, Kanagawa (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/480,920

(22) Filed: Jun. 9, 2009

(30) Foreign Application Priority Data
Jun. 16, 2008 (JP) 2008-156909

(51) Int. Cl. B32B 15/02; H01B 1/22; C22C 5/06

(52) U.S. Cl. 428/401; 252/514; 75/330; 420/501; 977/810; 977/895

(57) ABSTRACT

To provide a method for producing a silver nanowire, including heating a silver complex in an aqueous solvent at a temperature equal to or below the boiling point of the aqueous solvent in the presence of at least one of a hydroxyketone compound and a hydroxylamine compound, and a silver nanowire obtained by the method.

### BACKGROUND OF THE INVENTION

1. Field of the Invention

The present invention relates to a silver nanowire capable of satisfying both the transparency and the conductivity, a method for producing the silver nanowire, and an aqueous dispersion using the silver nanowire.

2. Description of the Related Art

To produce an aqueous dispersion of silver nanowires having a long axis of 1 μm or more and a short axis of 100 nm or less, some methods are proposed, in which a silver nanowire-polyol dispersion prepared by a polyol method, is subjected to centrifugal separation and subsequent solvent replacement so as to produce an aqueous dispersion (U.S. Patent Application Publication Nos. 2005/0056118 and 2007/0074316).

As a method for synthesizing silver nanowires using an aqueous solvent, there is proposed a method for producing nanowires having a long axis of several ten micrometers and a short axis of 28 nm by using ammonia silver in an autoclave at 120° C. for 8 hours (J. Phys. Chem. B 2005, 109, 5497).

Meanwhile, as a method for synthesizing silver nanowires using an aqueous solvent at 100° C. or less instead of ammonium, there is proposed a method for producing silver nanowires having a long axis of several ten micrometers to 100 μm and a short axis of 80 nm in an aqueous solvent at 45° C. for overnight or longer (Adv. Funct. Mater. 2004, 14, 183).

Another method for producing silver nanowires is proposed in which silver nanowires having a long axis of 300 nm to 4 μm and a short axis of 15 nm are produced in an aqueous solvent at 100° C. (J. Solid State Chemistry 179 (2006) 696).

Another method for producing silver nanowires is proposed in which silver nanowires having a short axis of 90 nm to 300 nm are produced by immersing a glass substrate, on which cupper fine particles are electrically deposited, into an aqueous silver nitrate solution overnight (Japanese Patent Application Laid Open (JP-A) No. 2006-028606).

Although many methods for producing silver nanowires have been proposed in these documents and the like, there still has been a demand for producing nanowires efficiently, and cost effectively in a short time using an aqueous solvent without pressurization by an autoclave or the like. Moreover, it is desired to prevent silver nanowires having a small short axis from being oxidized, and it is desired for silver nanowires having a large short axis to improve the transparency.

Thus, there is still a demand for silver nanowires having a short axis of 5 nm to 500 nm, which can satisfy all the above conditions.

### BRIEF SUMMARY OF THE INVENTION

The present invention relates to a silver nanowire capable of satisfying both the transparency and the conductivity, a method for producing a silver nanowire in an aqueous solvent at a temperature equal to or below the boiling point of the solvent in the presence of at least one of a hydroxyketone compound and a hydroxylamine compound, and an aqueous dispersion containing the silver nanowire and having improved storage stability after coating and dispersion stability.

The present invention provides the following in order to solve the above-described problems.

<1> A method for producing a silver nanowire, including heating a silver complex in an aqueous solvent at a temperature equal to or below the boiling point of the aqueous solvent in the presence of at least one of a hydroxyketone compound and a hydroxylamine compound.
<2> The method for producing a silver nanowire according to <1>, wherein the hydroxyketone compound is a compound expressed by General Formula (I) and the hydroxylamine compound is a compound expressed by General Formula (II):

R₁—C(═O)—CH(OH)—R₂ General Formula (I)

R₃—N(OH)—R₄ General Formula (II)

in General Formulas (I) and (II), R₁, R₂, R₃ and R₄ each represent a hydrogen atom or a substituent, and R₁ and R₂, and R₃ and R₄ may respectively be bonded together to form a ring structure.

<3> The method for producing a silver nanowire according to <2>, wherein the compounds expressed by General Formulas (I) and (II) have a solubility in water at 25° C. of 0.1 or higher, and is sublimated and/or decomposed to become volatile after a reaction.
<4> The method for producing a silver nanowire according to <1>, wherein the silver complex is a silver ammonia complex.
<5> The method for producing a silver nanowire according to <1>, wherein a silver halide is formed before the silver nanowire is produced.
<6> A silver nanowire obtained by a method for producing a silver nanowire, wherein the method includes heating a silver complex in an aqueous solvent at a temperature equal to or below the boiling point of the aqueous solvent in the presence of at least one of a hydroxyketone compound and a hydroxylamine compound.
<7> The silver nanowire according to <6>, wherein the silver nanowire has a short axis ranging from 5 nm to 500 nm in length.
<8> An aqueous dispersion containing a silver nanowire, wherein the silver nanowire is obtained by a method for producing a silver nanowire, the method includes heating a silver complex in an aqueous solvent at a temperature equal to or below the boiling point of the aqueous solvent in the presence of at least one of a hydroxyketone compound and a hydroxylamine compound.
<9> A transparent conductor including a transparent conductive layer formed from an aqueous dispersion containing a silver nanowire which is obtained by a method for producing a silver nanowire, wherein the method includes heating a silver complex in an aqueous solvent at a temperature equal to or below the boiling point of the aqueous solvent in the presence of at least one of a hydroxyketone compound and a hydroxylamine compound.

The present invention can solve conventional problems, and provide a silver nanowire capable of satisfying both the transparency and the conductivity, a method for producing a silver nanowire in an aqueous solvent at a temperature equal to or below the boiling point of the solvent in the presence of at least one of a hydroxyketone compound and a hydroxylamine compound, an aqueous dispersion containing the silver nanowire and having improved storage stability after coating and dispersion stability, and a transparent conductor.

### BRIEF DESCRIPTION OF THE DRAWINGS

FIG. 1 is a transmission electron microscope (TEM) image of silver nanowires in Sample 101 in Examples.

FIG. 2 is a transmission electron microscope (TEM) image of silver nanowires in Sample 108 in Examples.

FIG. 3 is a transmission electron microscope (TEM) image of Comparative Sample 111 in Examples.

### DETAILED DESCRIPTION OF THE INVENTION

### Method for Producing Silver Nanowire and Silver Nanowire

A method for producing a silver nanowire of the present invention is characterized by heating a silver complex in an aqueous solvent at a temperature equal to or below the boiling point of the aqueous solvent in the presence of at least one of a hydroxyketone compound and a hydroxylamine compound.

A silver nanowire of the present invention is produced by a method for producing a silver nanowire of the present invention.

Hereinafter, the method for producing the silver nanowire of the present invention, along with the silver nanowire, will be explained in detail.

In the present invention, a silver complex is heated in an aqueous solvent at a temperature equal to or below the boiling point of the aqueous solvent in the presence of at least one of a hydroxyketone compound and a hydroxylamine compound (a reducing agent), and if necessary, preferably in the presence of a dispersant and a halogen compound, and subjected to a reduction reaction, so as to produce silver nanowires. Thereafter, if necessary, the reactant may be subjected to desalting process. The desalting process is preferably performed depending on the application, because it can decrease the conductivity of the aqueous dispersion.

The aqueous solvent preferably contains 20% or more of water. The solvent other than water is preferably a hydrophilic solvent. Examples of the hydrophilic solvents include alcohols such as methanol, ethanol, propanol, isopropanol, and butanol; ketones such as acetone; cyclic ethers such as tetrahydrofuran and dioxane.

The heating temperature is preferably 100° C. or lower, more preferably 40° C. to 100° C., more preferably 50° C. to 100° C., and even more preferably 50° C. to 90° C.

When the heating temperature is higher than 100° C., the coated film may have a low transmittance because the amount of a dispersant that strongly adsorbs to the particles may be reduced. As the heating temperature becomes lower, the reduction reaction proceeds slower. Thus, formation of the silver nanowires takes long time. This may cause that the silver nanowires are easily entangled, adversely affecting the dispersion stability of the silver nanowires. This tendency is especially remarkable at 40° C. or lower.

The reaction for producing the silver nanowires is preferably performed under atmospheric pressure without additional pressure. Although the reaction may be performed with or without stirring, it is preferable to perform it with stirring.

The silver complex is not particularly limited, and may be appropriately selected according to the purpose. Examples of ligands for the silver complex include CN⁻, SCN⁻, SO₃²⁻, thiourea, and ammonia. Please refer to “The theory of the photographic process, 4^{th} edition, Macmillan Publishing, T. H. James.” Of the silver complexes, a silver ammonia complex is particularly preferable.

### —Reducing Agent—

The heating process is performed in the presence of at least one of a hydroxyketone compound and a hydroxylamine compound as a reducing agent.

R₁—C(═O)—CH(OH)—R₂ General Formula (I)

R₃—N(OH)—R₄ General Formula (II)

in General Formulas (I) and (II), R₁, R₂, R₃ and R₄ each represent a hydrogen atom or a substituent, and R₁ and R₂, and R₃ and R₄ may respectively be bonded together to form a ring structure.

Examples of the substituents include a hydrogen atom; an alkyl group having carbon atoms of 1 to 8, such as a methyl group, ethyl group, n-propyl group, isopropyl group, n-butyl group, and t-butyl group; an acyl group having carbon atoms of 1 to 8, such as a formyl group, acetyl group, malonyl group and benzoyl group; an aromatic group, such as a phenyl group; an amino group; a carbamoyl group; and a heterocyclic group, such as furan, thiophene, pyrrole and pyridine. These substituents may be further substituted with a substituent.

R₁ and R₂, and R₃ and R₄ may respectively be bonded together to form a ring structure. Examples of the ring structures include a cyclohexane ring, oxolane ring, and pyrrolidine ring.

R₃ and R₄ together may form oxime, such as acetoxime, acetaldoxime, and glyoxime.

As the hydroxyketone compound and hydroxylamine compound, those having high solubility in water are preferably used. It is preferred that the solubility of these compounds in water at 25° C. be preferably 0.1 or higher. Moreover, the conductivity is adversely affected by a large amount of a residue derived from the hydroxyketone compound or hydroxylamine compound, after reduction reaction of the compound. Thus, the compounds preferably generate less amount of residue after the reduction reaction. Furthermore, it is preferred that the compounds become volatile (sublimated) after the reaction, or that the compounds be decomposed and become volatile after the reaction.

The amount of the reducing agent, i.e. the hydroxyketone compound or hydroxylamine compound, is not particularly limited and may be appropriately selected according to the purpose. The amount of the reducing agent is preferably 0.5 moles to 5 moles, and more preferably 1 mole to 3 moles, per 1 mole of silver. The hydroxyketone compound or hydroxylamine compound may be added before or after addition of a dispersant, or before or after addition of a halogen compound.

Hereinafter, the hydroxyketone compound and hydroxylamine compound will be specifically exemplified. However, the present invention is not limited to these compounds.

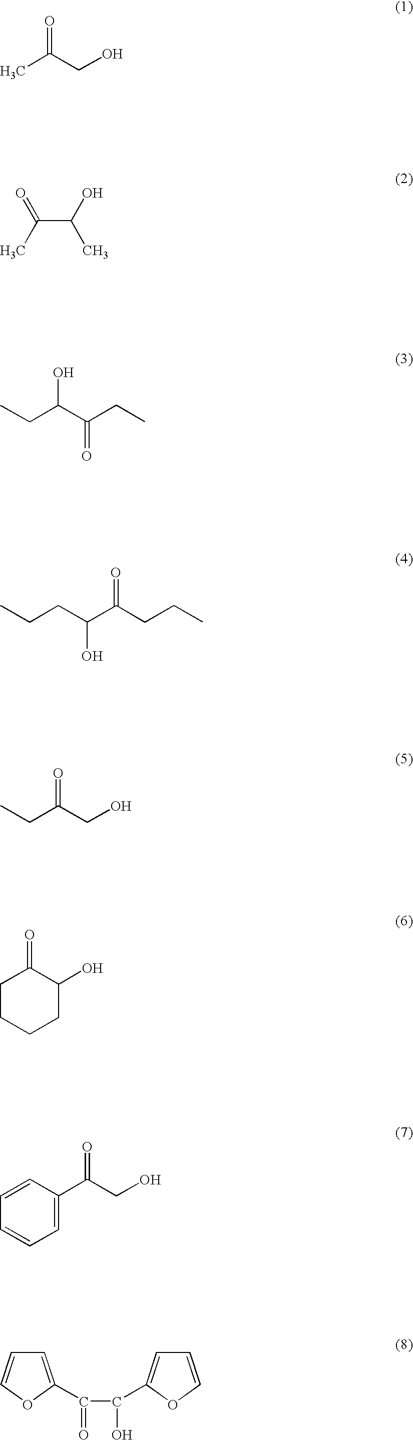

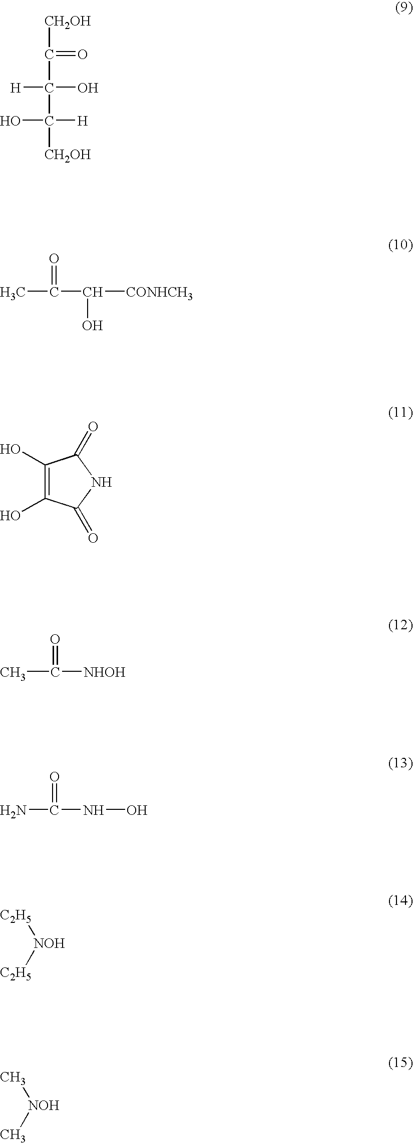

### —Dispersant—

The dispersant is not particularly limited and may be appropriately selected according to the purpose. Examples of the dispersants include amino group-containing compounds, thiol group-containing compounds, sulfide group-containing compounds, amino acids and derivatives thereof, peptide compounds, polysaccharides, polysaccharide-derived natural polymers, synthetic polymers, and polymers such as gels derived therefrom. Additionally, cationic, anionic or neutral surfactants may be used. Of these, quaternary ammonium salts such as hexadecyl-trimethylammonium bromide, octyl-trimethylammonium chloride, decyl-triethylammonium nitrate, and pyridinium salts such as hexadecylpyridinium bromide are particularly preferred.

The polymer is not particularly limited and may be appropriately selected according to the purpose. Examples of the polymers include polymers having protective colloid properties, such as gelatin, polyvinyl alcohol, methyl cellulose, hydroxypropyl cellulose, polyalkylene amine, partial alkyl esters of polyacrylic acid, polyvinyl pyrrolidone, and copolymers thereof.

As for the structures usable as the dispersant, “A cyclopaedia of pigments,” edited by Seishiro Ito, Asakura Publishing Co., Ltd., 2000, can be referred to.

The shape of the nanowire can be varied according to the type of the dispersant used.

When the silver nanowires are produced, a silver halide is produced. That is, a silver halide is formed before the silver nanowires are produced.

The dispersant may be added before the production of the silver halide, or may be added to control the dispersion state after the production of the silver halide. The dispersant is preferably added before the production of the silver halide.

When the silver nanowires of the present invention are produced, the dispersant and the halogen compound are preferably added. The shape of the nanowire can be controlled by adjusting the amount of the dispersant and the halogen compound.

The silver halide fine particles may be used instead of the halogen compound, or in combination with the halogen compound.

The halogen compound is not particularly limited as long as it contains bromine, chlorine or iodine, and may be appropriately selected according to the purpose. Examples of the halogen compound include alkali halides such as sodium bromide, sodium chloride, sodium iodide, potassium iodide, potassium bromide, potassium chloride; and materials serving as the dispersants shown below. The halogen compound may be added before or after addition of the dispersant, or before or after addition of the reducing agent. A part of the halogen compound can form silver halide.

A material serving as both the dispersant and the halogen compound may be used. Examples of the compounds serving as both the dispersant and the halogen compound include HTAB (hexadecyl-trimethylammonium bromide) which has a quaternary amino group and a bromide ion, HPyB (hexadecylpyridinium bromide), and HTAC (hexadecyl-trimethylammonium chloride) which has a quaternary amino group and a chloride ion.

The above-mentioned desalting process can be performed, after the formation of the silver nanowires, by ultrafiltration, dialysis, gel filtration, decantation, centrifugation, or the like.

### <Silver Nanowire>

The shape of the silver nanowire is not particularly limited and may be appropriately selected according to the purpose. For example, it may have any shape, such as a cylinder, a rectangle, or a columnar structure having a polygonal cross section.

The length of a long axis of the silver nanowire is preferably 1 μm to 500 μm, more preferably 5 μm to 250 μm, and even more preferably 10 μm to 100 μm.

The length of a short axis of the silver nanowire is preferably 5 nm to 500 nm, more preferably 10 nm to 100 nm, and even more preferably 10 nm to 50 nm.

When the length of the long axis is less than 1 μm, in the case of the conductor produced by coating, the area of contact points between metals is small, and it becomes hard to bring them into conduction. As a result, electrical resistance may become high. When the length of the long axis is greater than 500 μm, the silver nanowires are easily entangled with each other, adversely affecting the dispersion stability.

When the length of the short axis is greater than 500 nm, the performance as a conductor may be improved, but a problem arises that the occurrence of haze due to light scattering is so remarkable that the transparency degrades. When the length of the short axis is less than 5 nm, the transparency may be improved, but the conductivity is adversely affected by oxidation.

Here, the lengths of the long axis and short axis may be determined by observing TEM images using a transmission electron microscope (TEM).

### (Aqueous Dispersion)

The aqueous dispersion of the present invention contains the silver nanowires of the present invention, in a dispersion solvent.

The amount of the silver nanowires in the aqueous dispersion is preferably 0.1% by mass to 99% by mass, and more preferably 0.3% by mass to 95% by mass. When the amount is less than 0.1% by mass, the load in production and drying processes is extremely large. When the amount is more than 99% by mass, the particles may aggregate.

The aqueous dispersion particularly preferably contains silver nanowires having a long axis with a length of 10 μm or more, in an amount of 0.01% by mass or more, and more preferably 0.05% by mass or more, in view that the conductivity can be increased by coating a smaller amount of silver, which does not impair the transparency.

The dispersion solvent for the aqueous dispersion of the present invention mainly contains water, and may further contain an organic solvent miscible with water in a ratio of 80% by volume or less.

The organic solvent is preferably an alcohol compound having a boiling point of 50° C. to 250° C., and more preferably 55° C. to 200° C. Water and the alcohol compound are combined so as to improve coating performance in the coating step and reduce a dry load.

The alcohol compound is not particularly limited and may be appropriately selected according to the purpose. Examples thereof include methanol, ethanol, ethylene glycol, diethylene glycol, triethylene glycol, polyethylene glycol 200, polyethylene glycol 300, glycerine, propylene glycol, dipropylene glycol, 1,3-propane diol, 1,2-butane diol, 1,4-butane diol, 1,5-pentane diol, 1-ethoxy-2-propanol, ethanolamine, diethanolamine, 2-(2-aminoethoxy)ethanol, and 2-dimethylaminoisopropanol. These compounds may be used alone or in combination. Of these, ethanol and ethylene glycol are more preferable.

It is preferred that the aqueous dispersion of the present invention contain inorganic ions, such as alkali metal ion, alkaline earth metal ion, or halide ion, as small amount as possible.

The aqueous dispersion has a conductivity of preferably 1 mS/cm or less, more preferably 0.1 mS/cm or less, and even more preferably 0.05 mS/cm or less.

The aqueous dispersion has a viscosity at 20° C. of preferably 0.5 mPa·s to 100 mPa·s, and more preferably 1 mPa·s to 50 mPa·s.

The aqueous dispersion of the present invention may contain, if necessary, various additives such as surfactants, polymerizable compounds, antioxidants, antisulfurization agents, corrosion inhibitors, viscosity modifiers, and antiseptic agents.

The corrosion inhibitor is not particularly limited and may be appropriately selected according to the purpose. An azole compound is preferably used as the corrosion inhibitor. Examples of the azole compounds include at least one selected from the group consisting of benzotriazole, tolyltriazole, mercaptobenzothiazole, mercaptobenzotriazole, mercaptobenzotetrazole, (2-benzothiazolylthio)acetic acid, 3-(2-benzothiazolylthio)propionic acid, alkali metal salts thereof, ammonium salts thereof, and amine salts thereof. The presence of the corrosion inhibitor ensures markedly excellent anti-rust effect. The corrosion inhibitor can be used by directly adding to the aqueous dispersion in the form of a solution in which the corrosion inhibitor is dissolved in an appropriate solvent, or in a form of powder; or by immersing a produced transparent conductor described later into a bath containing the corrosion inhibitor.

Alternatively, the silver nanowires are produced according to the method of the present invention, and then the surface of the silver nanowires can be coated with a stable metal thin film so as to prevent it from corrosion, by applying a mixture of the silver nanowires and a solution containing a salt of metal, such as gold, platinum, and palladium, having an electric potential more positive than the oxidation-reduction potential of silver, or by immersing a produced transparent conductor described later into a bath containing the salt of metal.

The aqueous dispersion of the present invention may be used as an aqueous ink for an inkjet printer or a dispenser.

In the image formation by using an inkjet printer, a substrate on which the aqueous dispersion is coated is as exemplified by a paper, a coated paper, and a PET film which surface is coated with a hydrophilic polymer.

### (Transparent Conductor)

The transparent conductor has a transparent conductive layer formed from the aqueous dispersion of the present invention. In order to produce the transparent conductor, the aqueous dispersion of the present invention is coated onto the substrate and the coated substrate is then dried.

Hereinafter, the transparent conductor is explained in detail through describing a method for producing the transparent conductor.

The substrate on which the aqueous dispersion is coated is not particularly limited and may be appropriately selected according to the purpose. Examples of the substrates for the transparent conductor include the following materials. Of these, a polymer film is preferable in terms of production suitability, lightness, flexibility, and optical properties (polarization). More preferable are PET, TAC and PEN films.

(1) Glass such as quartz glass, non-alkali glass, crystallized transparent glass, PYREX (a registered trade mark) glass, and sapphire.

(2) An acryl resin such as polycarbonate and polymethacrylate; a vinyl chloride resin such as polyvinyl chloride and vinyl chloride copolymer; a thermoplastic resin such as polyarylate, polysulfone, polyethersulfone, polyimide, PET, PEN, a fluorocarbon resin, a phenoxy resin, a polyolefin resin, nylon, a styrene resin, and an ABS resin.

(3) A thermosetting resin such as an epoxy resin.

These substrate materials may be used in combination, as necessary. Any material is appropriately selected from these substrate materials depending on the application, and formed into a flexible substrate such as a film or as a rigid substrate. For example, a substrate formed by combining glass having a thickness of 10 μm to 50 μm and the resin, is preferred in terms of excellent flexibility and gas barrier property.

The shape of the substrate may be any of disc, card, or sheet. The substrate may be laminated three-dimensionally. The substrate may have a fine pore or fine groove having an aspect ratio of 1 or more on the surface where the circuit is to be printed. Into the fine pores or fine grooves, the aqueous dispersion of the present invention may be ejected by an inkjet printer or a dispenser.

The surface of the substrate may be preferably treated to be hydrophilic. Specifically, it is preferable for the surface of the substrate to be coated with a hydrophilic polymer. With such a hydrophilization treatment, the coating property and/or adhesiveness of the aqueous dispersion onto the substrate are improved.

The hydrophilization treatment is not particularly limited and may be appropriately selected according to the purpose. Examples thereof include a chemical treatment, mechanical surface roughening treatment, corona discharge treatment, flame treatment, ultraviolet treatment, glow discharge treatment, active plasma treatment, and laser treatment. The surface tension of the substrate is preferably 30 dyne/cm or more by any of the hydrophilization treatments.

The hydrophilic polymer to be coated on the surface of the substrate is not particularly limited and may be appropriately selected according to the purpose. Examples thereof include gelatin, gelatin derivative, casein, agar, starch, polyvinyl alcohol, polyacrylic acid copolymer, carboxymethyl cellulose, hydroxyethyl cellulose, polyvinyl pyrrolidone, and dextran.

The thickness of the hydrophilic polymer layer (after dried) is preferably 0.001 μm to 100 μm, and more preferably 0.01 μm to 20 μm.

It is preferable to incorporate a hardening agent into the hydrophilic polymer layer to enhance the film strength. The hardening agent is not particularly limited and may be appropriately selected according to the purpose. Examples thereof include aldehyde compounds such as formaldehyde and glutaric aldehyde; ketone compounds such as diacetyl and cyclopentanedion; vinyl sulfone compounds such as divinylsulfone; triazine compounds such as 2-hydroxy-4,6-dichloro-1,3,5-triazine; isocyanate compounds disclosed in the U.S. Pat. No. 3,103,437.

The hydrophilic polymer layer can be formed by a process in which the above compound is dissolved or dispersed in any proper solvent such as water to prepare a coating liquid, and then the liquid is coated on the hydrophilized surface of the substrate by any of coating methods such as spin coating, dip coating, extrusion coating, bar coating and die coating. It is preferable to introduce an undercoat layer between the substrate and the hydrophilic polymer layer in order to further improve the adhesiveness. The temperature for the drying is preferably 120° C. or less, more preferably 30° C. to 100° C., and even more preferably 40° C. to 80° C.

In the present invention, after production of a transparent conductor, the produced conductor is preferably passed through a corrosion inhibitor bath to thereby obtain more excellent corrosion inhibiting effect.

### —Application—

The transparent conductor is widely used in touch panels, antistatic treatments for displays, electromagnetic interferences shields, electrodes for organic or inorganic EL displays, electrodes for flexible displays, electrodes for solar cells, antistatic films and electronic paper.

### EXAMPLES

Hereinafter, Examples of the present invention will be described. However, these Examples should not be construed as limiting the present invention.

In Examples and Comparative Examples shown below, “an average particle diameter (lengths of the long axis and short axis) of silver nanowires” and “a viscosity of aqueous dispersion” were measured in the following manner.

### <Average Particle Diameter (Length of Long Axis and Short Axis) of Silver Nanowire>

The average particle diameter of silver nanowires was measured by observing TEM images using a transmission electron microscope (TEM; JEM-2000FX, produced by JEOL Ltd.).

### <Viscosity of Aqueous Dispersion>

The viscosity of aqueous dispersion at 25° C. was measured using VISCOMATE VM-1G (produced by CBC Co., Ltd.).

### Example 1

### Preparation of Aqueous Dispersion of Silver Nanowires

### —Preparation of Additive Liquid A—

A silver nitrate powder (0.51 g) was dissolved in 50 mL of pure water. Then, 1N ammonia water was added to the silver nitrate solution until the mixed solution became transparent. Pure water was further added to adjust the total volume of the solution to 100 mL, thereby preparing Additive Liquid A.

### —Preparation of Reducing Agent Solution B—

Reducing Agent (1) expressed by the following structural formula (0.22 g) was dissolved in 150 mL of pure water, so as to prepare Reducing Agent Solution B.

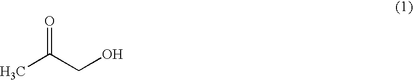

Reducing Agent (1) is a compound which is miscible with water at 25° C., and is sublimated and/or decomposed to become volatile after a reaction.

### —Preparation of Additive Liquid C—

A HTAB (hexadecyl-trimethylammonium bromide) powder (1.82 g) as a compound serving as both a dispersant and a halogen compound was dissolved by heating in 100 mL of pure water so as to prepare Additive liquid C.

### —Preparation of Sample 101—

Pure water (63 mL) and 33.2 mL of Additive liquid C were poured into a three-neck flask and stirred at 200 rpm at room temperature. Reducing Agent Solution B (50 mL) and 41.2 mL of Additive liquid A were further added in the flask, in order, and then heated at a liquid temperature of 75° C. for 5 hours under atmospheric pressure.

The resultant aqueous dispersion was cooled, centrifuged, and purified until the conductivity became 50 μS/cm or less, so as to obtain Aqueous Dispersion of Silver Nanowires 101.

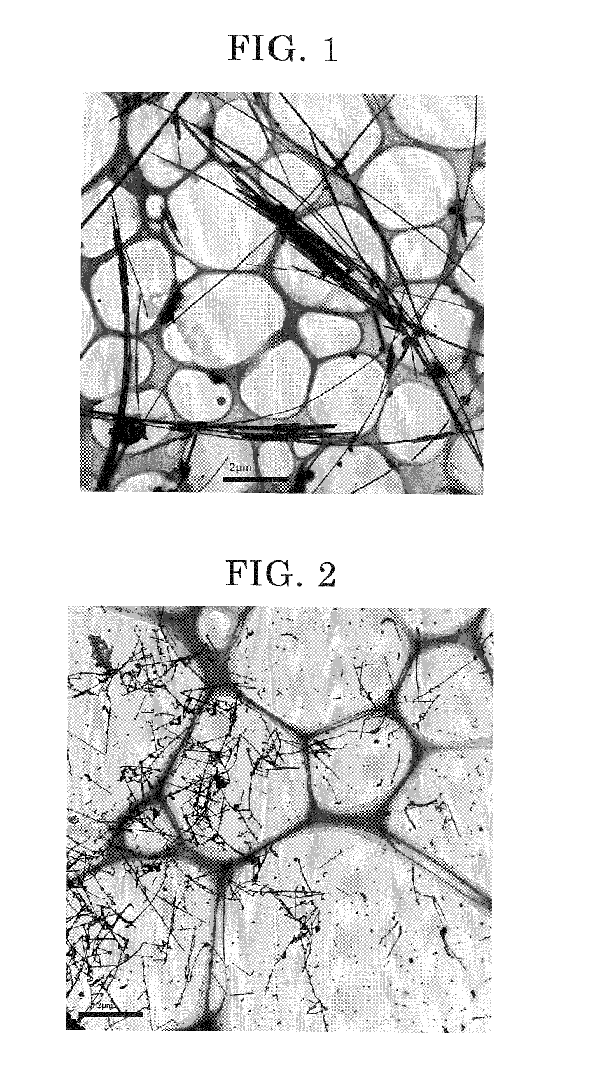

The silver nanowires in the obtained Sample 101 had a short axis ranging from 20 nm to 60 nm in length and a long axis ranging from 30 μm to 70 μm in length, shown in a TEM image of FIG. 1. Using an XRD apparatus (RINT2500, produced by Rigaku Corporation), the diffraction pattern of metallic silver was obtained.

### —Preparation of Sample 102—

Aqueous Dispersion of Silver Nanowires 102 was prepared in the same manner as in Sample 101, except that Reducing Agent (1) used for preparation of Reducing Agent Solution B in Sample 101 was replaced with equimolar amount of Reducing Agent (2) expressed by the following Structural Formula.

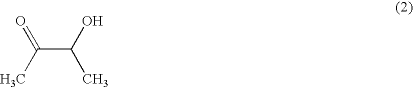

Reducing Agent (2) is a compound having a solubility of 1 or more in water at 25° C., and is sublimated and/or decomposed to become volatile after a reaction.

### —Preparation of Sample 103—

Aqueous Dispersion of Silver Nanowires 103 was prepared in the same manner as in Sample 101, except that Reducing Agent (1) used for preparation of Reducing Agent Solution B in Sample 101 was replaced with equimolar amount of Reducing Agent (7) expressed by the following Structural Formula.

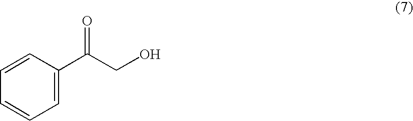

Reducing Agent (7) is a compound having a solubility of 0.3 or more in water at 25° C., and is sublimated and/or decomposed to become volatile after a reaction.

### —Preparation of Sample 104—

Aqueous Dispersion of Silver Nanowires 104 was prepared in the same manner as in Sample 101, except that Reducing Agent (1) used for preparation of Reducing Agent Solution B in Sample 101 was replaced with equimolar amount of Reducing Agent (9) expressed by the following Structural Formula.

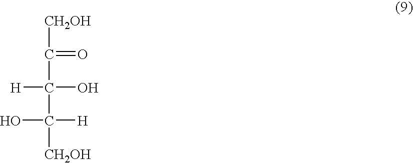

Reducing Agent (9) is a compound having a solubility of 10 or more in water at 25° C., and is sublimated and/or decomposed to become volatile after a reaction.

### —Preparation of Sample 105—

Aqueous Dispersion of Silver Nanowires 105 was prepared in the same manner as in Sample 101, except that Reducing Agent (1) used for preparation of Reducing Agent Solution B in Sample 101 was replaced with equimolar amount of Reducing Agent (14) expressed by the following Structural Formula.

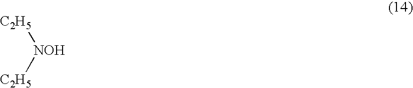

Reducing Agent (14) is a compound having a solubility of 10 or more in water at 25° C., and is sublimated and/or decomposed to become volatile after a reaction.

Each of the silver nanowires in the obtained Samples 102 to 105 had a short axis ranging from 20 nm to 100 nm in length and a long axis ranging from 20 μm to 50 μm in length.

### —Preparation of Sample 106—

Aqueous Dispersion of Silver Nanowires 106 was prepared in the same manner as in Sample 101, except that HTAB of Additive Liquid C in Sample 101 was replaced with HPyB (hexadecylpyridinium bromide).

The silver nanowires in the obtained Sample 106 had a short axis ranging from 15 nm to 30 nm in length and a long axis ranging from 20 μm to 50 μm in length.

### —Preparation of Sample 107—

Aqueous Dispersion of Silver Nanowires 107 was prepared in the same manner as in Sample 101, except that the silver nitrate of Additive Liquid A in Sample 101 was replaced with equimolar amount of silver lactate.

The silver nanowires in the obtained Sample 107 had a short axis ranging from 15 nm to 30 nm in length and a long axis ranging from 40 μm to 60 μm in length.

### —Preparation of Sample 108—

Aqueous Dispersion of Silver Nanowires 108 was prepared in the same manner as in Sample 101, except that HTAB of Additive Liquid C in Sample 101 was replaced with equimolar amount of HTAC (hexadecyl-trimethylammonium chloride), and the liquid mixture was heated at 60° C. for 5 hours.

The silver nanowires in the obtained Sample 108 had a short axis ranging from 20 nm to 40 nm in length and a long axis ranging from 1 μm to 20 μm in length, shown in a TEM image of FIG. 2.

### —Preparation of Comparative Sample 111—

Aqueous Dispersion of Comparative Sample 111 was prepared in the same manner as in Sample 101, except that the liquid mixture was heated at a temperature of 120° C. and a pressure of 1.8 atom for 5 hours in an autoclave.

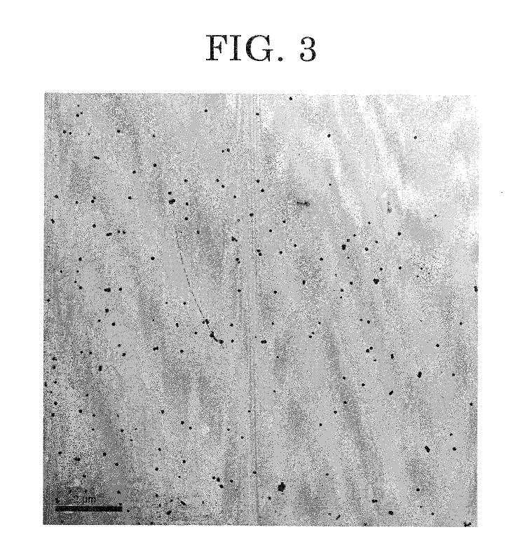

In the obtained Comparative Sample 111, silver nanowires were not observed as shown in a TEM image of FIG. 3.

### —Preparation of Comparative Sample 112—

Aqueous Dispersion of Comparative Sample 112 was prepared in the same manner as in Sample 101, except that Reducing Agent (1) used for preparation of Reducing Agent Solution B in Sample 101 was replaced with equimolar amount of L-ascorbic acid.

In the obtained Comparative Sample 112, silver nanowires were not observed.

### —Preparation of Comparative Sample 113—

Aqueous Dispersion of Comparative Sample 113 was prepared in the same manner as in Sample 101, except that Reducing Agent (1) used for preparation of Reducing Agent Solution B in Sample 101 was replaced with equimolar amount of hydroquinone.

In the obtained Comparative Sample 113, silver nanowires were not observed.

In each of the obtained Samples 101 to 108 and Comparative Samples 111 to 113, the amount of silver was adjusted to be 22% by mass to thereby produce each aqueous dispersion for coating. Any of these aqueous dispersions for coating had viscosities of 10 mPa·s or less at 25° C.

A commercially available, biaxially-oriented and thermally stabilized polyethylene terephthalate (PET) substrate having a thickness of 100 μm was subjected to corona discharge treatment at 8 W/m²/min, and then an undercoat layer having the following composition was coated thereon so as to have a dry thickness of 0.8 μm.

### —Composition of Undercoat Layer—

The undercoat layer contains a copolymer latex consisting of butylacrylate (40% by mass), styrene (20% by mass) and glycidylacrylate (40% by mass); and 0.5% by mass of hexamethylene-1,6-bis(ethyleneurea).

Next, the surface of the undercoat layer was subjected to a corona discharge treatment at 8 W/m²/min, and then hydroxyethyl cellulose was coated thereon as a hydrophilic polymer layer so as to have a dried thickness of 0.2 μm.

Then, using a doctor coater, each of the aqueous dispersions for coating of Samples 101 to 108 and Comparative Samples 111 to 113 was applied on the hydrophilic polymer layer, and then dried. The coated amount of silver was measured using a fluorescent X-ray analyzer, and the coated amount was adjusted to 0.03 g/m² (SEA1100, produced by Seiko Instruments, Inc.).

The properties of the coat were evaluated as follows. Results are shown in Table 1.

### <Transmittance of Coat>

The transmittance of the coat was measured at a wavelength of 400 nm to 800 nm using UV-2550 (produced by Shimadzu Corporation).

### <Surface Resistance of Coat>

The surface resistance was measured using LORESTA-GP MCP-T600 (produced by Mitsubishi Chemical Corporation).

### <Dispersion Stability of Aqueous Dispersion for Coating>

After the aqueous dispersion was stirred with a magnetic stirrer, the aqueous dispersion was moved into a transparent acryl cell having 5 cm length×5 cm width×30 cm height, and then allowed to stand for 3 hours. A liquid at a depth of 2 cm from the surface of water was drawn as a sample, and the ultraviolet transmission absorption spectrum of the sample was measured by UV-2550 (produced by Shimadzu Corporation) so as to evaluate dispersion stability. As a reference, the dispersion stability of a water-filled optical cell was defined as 100%. A sample having high dispersion stability was low in transmittance even near the surface of water, and a sample having low dispersion stability was high in transmittance near the surface of water because of marked sedimentation.

Evaluation criteria were as follows. The dispersion stability improves with the increase of the number.

### [Evaluation Criteria]

1. Transmittance was 90% or higher, sedimentation occurred markedly, and the sample was problematic level in practical terms.

2. Transmittance was 70% or higher and lower than 90%, sedimentation was recognizable, and the sample was problematic level in practical terms.

3. Transmittance was 50% or higher and lower than 70%, slight sedimentation was seen, and the sample had no problem in practical terms.

4. Transmittance was 30% or higher and lower than 50%, little sedimentation was seen, and the sample had no problem in practical terms.

5. Transmittance was 0% or higher and lower than 30%, no sedimentation was seen, and the sample had no problem in practical terms.

TABLE 1

| Sample | Transmittance | Surface Resistance | Dispersion | |
|---|---|---|---|---|
| No. | (%) | (Ω/cm²) | Stability | |
| 101 | 86 | 112 | 5 | Example |
| 102 | 83 | 105 | 5 | Example |
| 103 | 80 | 110 | 4 | Example |
| 104 | 83 | 125 | 4 | Example |
| 105 | 85 | 100 | 5 | Example |
| 106 | 86 | 130 | 4 | Example |
| 107 | 85 | 117 | 5 | Example |
| 108 | 87 | 210 | 5 | Example |
| 111 | 90 | >1 × 10⁶ | 5 | Comparative |
| | | | | Example |
| 112 | 88 | >1 × 10⁶ | 4 | Comparative |
| | | | | Example |
| 113 | 87 | >1 × 10⁶ | 4 | Comparative |
| | | | | Example |

The silver nanowire and the aqueous dispersion of the present invention capable of satisfying both the transparency and the conductivity, and are widely used in touch panels, antistatic treatments for displays, electromagnetic interference shields, electrodes for organic or inorganic EL displays, electrodes for flexible displays, electrodes for solar cells, antistatic films and electronic paper.

What is claimed is:

1. A method for producing a silver nanowire, comprising:
heating a silver complex in an aqueous solvent at a temperature equal to or below the boiling point of the aqueous solvent in the presence of at least one of a hydroxyketone compound and a hydroxylamine compound.

2. The method for producing a silver nanowire according to claim 1, wherein the hydroxyketone compound is a compound expressed by General Formula (I) and the hydroxylamine compound is a compound expressed by General Formula (II):
R₁—C(═O)—CH(OH)R₂ General Formula (I)
R₃—N(OH)—R₄ General Formula (II)
in General Formulas (I) and (II), R₁, R₂, R₃ and R₄ each represent a hydrogen atom or a substituent, and R₁ and R₂, and R₃ and R₄ may respectively be bonded together to form a ring structure.

3. The method for producing a silver nanowire according to claim 2, wherein the compounds expressed by General Formulas (I) and (II) have a solubility in water at 25° C. of 0.1 or higher, and is sublimated or decomposed to become volatile after a reaction.

4. The method for producing a silver nanowire according to claim 1, wherein the silver complex is a silver ammonia complex.

5. The method for producing a silver nanowire according to claim 1, wherein a silver halide is formed before the silver nanowire is produced.

6. A silver nanowire obtained by a method for producing a silver nanowire, wherein the method comprises heating a silver complex in an aqueous solvent at a temperature equal to or below the boiling point of the aqueous solvent in the presence of at least one of a hydroxyketone compound and a hydroxylamine compound.

7. The silver nanowire according to claim 6, wherein the silver nanowire has a short axis ranging from 5 nm to 500 nm in length.

8. An aqueous dispersion comprising:
a silver nanowire,
wherein the silver nanowire is obtained by a method for producing a silver nanowire, the method comprises heating a silver complex in an aqueous solvent at a temperature equal to or below the boiling point of the aqueous solvent in the presence of at least one of a hydroxyketone compound and a hydroxylamine compound.
